(19) United States
(12) Patent Application Publication
(10) Pub. No.: US 2010/0260349 A1
(43) Pub. Date: Oct. 14, 2010

(54) SOLAR WIRELESS SOUND SYSTEM

(76) Inventor: Wenliang Chen, Fujian (CN)

Correspondence Address: Wenliang Chen;c/o Yu Chan, 42 PIN OAKS DRIVE, PHOENIXVILLE, PA, 19460, US

(21) Appl. No.: 12/747,169

(22) PCT Filed: May 11, 2009
(86) PCT No.: PCT/CN09/71727

§ 371 Date: Jun. 10, 2010

(30) Foreign Application Priority Data
May 12, 2008 (CN) 200820102309.1
Jun. 13, 2008 (CN) 200820115900.0
Jun. 13, 2008 (CN) 200820118960.8

(51) Int. Cl. H04B 3/00; H04R 27/00

(52) U.S. Cl. 381/82; 381/77

(57) ABSTRACT

A solar wireless audio system is provided. The solar wireless audio system includes a transmitting portion and a solar outdoor speaker. The transmitting portion includes a transmitting circuit and an audio input device connected with an input of the transmitting circuit. A receiving circuit and a power amplifier are inside the solar outdoor speaker, and the power amplifier is connected with output of the receiving circuit. Audio input device is a connecting interface for iPod player. Audio detection circuit and power management circuit are inside the solar outdoor speaker. Input of audio detection circuit is connected with output of receiving circuit. Output of audio detection circuit is connected with the inputs of power management circuit and power amplifier, respectively. Output of the power management circuit is connected with power control terminal of power amplifier. The solar outdoor speaker can be switched between sleep mode and active mode.

### BACKGROUND OF THE INVENTION

The present invention relates to an audio system, and especially relates to a solar wireless audio system.

The audio system generally includes an audio source, a power amplifier, and a speaker. In the present market, the solar wireless audio system generally includes a transmitting portion and a solar outdoor speaker, which serve as an audio source and a receiving portion, respectively. The power amplifier generally is placed inside the solar outdoor speaker. An input of the transmitting portion is connected with the audio source. By using the transmitting portion, audio signal is transmitted to the solar outdoor speaker to be broadcast. In general, the conventional audio source for the solar wireless audio system is in the form of a music module, thus the music stored therein is unable or cannot be easily updated. Furthermore, the solar outdoor speaker is always in a standby state, and this thereby wasting more energy.

### BRIEF SUMMARY OF THE INVENTION

An aspect of the present invention is to provide a solar wireless audio system. The solar wireless audio system has the advantage of being able to update music more easily. The solar outdoor speaker can be switched from a sleep mode into an active mode, thereby achieving automatic wake-up function.

The present invention relates generally to a solar wireless audio system. The solar wireless audio system includes a transmitting portion and a solar outdoor speaker. The transmitting portion includes a transmitting circuit and an audio input device. The audio input device is connected with an input of the transmitting circuit. A receiving circuit and a power amplifier are placed inside the solar outdoor speaker, and the power amplifier is connected with an output of the receiving circuit. The audio input device has a connecting interface for iPod® player. An audio detection circuit and a power management circuit are placed inside the solar outdoor speaker. An input of the audio detection circuit is connected with an output of the receiving circuit. An output of the audio detection circuit is connected with the inputs of the power management circuit and the power amplifier, respectively. An output of the power management circuit is connected with a power control terminal of the power amplifier.

In the above solar wireless audio system, the transmitting portion includes a low power player. The audio input device is connected with an input of the low power player.

In the above solar wireless audio system, the audio input device includes an audio input port.

In the above solar wireless audio system, the audio input device includes an AM/FM receiving circuit for receiving public broadcasts.

In the above solar wireless audio system, an audio source selection remote controller and an audio source selection circuit are included. The audio source selection circuit, corresponding to the audio source selection remote controller, is connected between the audio input device and an input of the transmitting circuit.

In the above solar wireless audio system, the electric power for the transmitting portion is supplied from public electric utility via a power adapter.

In the above solar wireless audio system, the electric power for the transmitting portion is supplied by a rechargeable battery. Furthermore, the transmitting portion includes a solar panel and the rechargeable battery is recharged by the solar panel.

In the above solar wireless audio system, an audio input port is disposed on the shell of the solar outdoor speaker. The audio input port is connected with the input of the audio detection circuit.

The solar wireless audio system includes the following advantages:

(1) It is easily to update the music by using the iPod player connecting with the solar wireless audio system;

(2) The audio detection circuit and the power management circuit located inside the solar outdoor speaker can be used to switch the solar outdoor speaker between the sleep mode and the active mode.

(3) It includes a plurality of audio sources. The audio sources are, for example, music players and from public broadcasts. Therefore, the user can select from a variety of different audio sources.

(4) The low power player installed in the transmitting portion can be used to access the tone quality of the music sources.

The above and other aspects, features, and advantages of the present invention will become more apparent from the following detailed description when taken in conjunction with the accompanying drawings.

### BRIEF DESCRIPTION OF THE DRAWINGS

FIG. 1 is a schematic diagram of a solar wireless audio system for an embodiment of the invention.

### DETAILED DESCRIPTION OF THE INVENTION

A solar panel is installed on the top of the solar outdoor speaker according to an embodiment of the invention. The photosensitive surface of the solar outdoor speaker faces upwards. A rechargeable battery, which is placed inside the solar outdoor speaker, is electrically connected with the solar panel. The electric power for the solar outdoor speaker is supplied by the solar panel and the rechargeable battery.

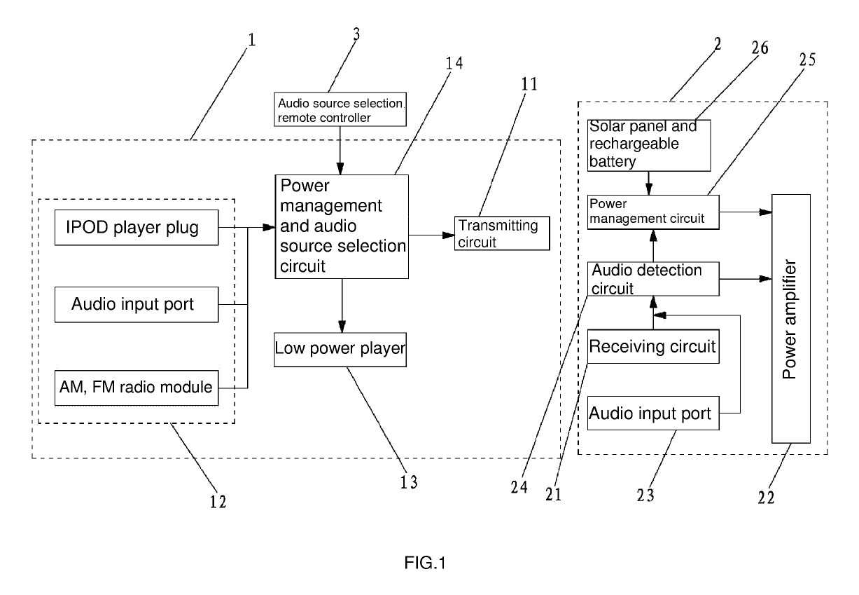

FIG. 1 is a schematic diagram of a solar wireless audio system for the embodiment of the invention. The solar wireless audio system includes a transmitting portion 1, a solar outdoor speaker 2, and an audio source selection remote controller 3.

The transmitting portion 1 includes a transmitting circuit 11, an audio input device 12, a low power player 13, and a power management and audio source selection circuit 14. The power management and audio source selection circuit 14 is corresponded to an audio source selection remote controller 3. The audio input device 12 is connected with an input of the transmitting circuit 11 and an input of the low power player 13, respectively, via the power management and audio source selection circuit 14. The audio input device 12 includes a connecting interface for the iPod player, an audio input port, and an AM/FM receiving module. The electric power for the transmitting portion 1 can be supplied by means of public electric utility via a power adapter, a rechargeable battery, a solar panel, or by a combination of the rechargeable battery and the solar panel. The transmitting portion 1 can further includes a display screen.

A receiving circuit 21, a rechargeable battery (not shown), and a power amplifier 22 are located inside the solar outdoor speaker 2. An audio input port 23 is disposed on the shell of the solar outdoor speaker 2. The solar panel is placed on the shell of the solar outdoor speaker 2. The electric power for the solar outdoor speaker 2 is supplied by the solar panel and the rechargeable battery 26. An audio detection circuit 24 and a power management circuit 25 are placed inside the solar outdoor speaker 2. An input of the audio detection circuit 24 is connected with the outputs of the receiving circuit 21 and the audio input port 23, respectively. An output of the audio detection circuit 24 is connected with the outputs of the power management circuit 25 and the power amplifier 22, respectively. Via the audio detection circuit 24, the audio signals from the audio input port 23 and the receiving circuit 21 are transmitted to an input of the power amplifier 22, respectively. An output of the power management circuit 25 is connected with a power control terminal of the power amplifier 22. The solar outdoor speaker 2 defaults the audio signal from the transmitting portion 1 to be as the default audio source. When the connecting interface of a music player is connected with the audio input port 23, the audio source of the solar outdoor speaker 2 is forced to switch to match the audio source of the music player connected with the audio input port 23.

The user can use the audio source selection remote controller 3 to select from a variety of different audio sources of the transmitting circuit 11. When a selection button on the audio source selection remote controller 3 is pressed, the audio source corresponding to the selection button is then connected with the audio selection circuit 14. Then, the audio signal from the audio source is transmitted by the transmitting circuit 11 to the receiving circuit 21 of the solar outdoor speaker 2. Thereafter, the audio signal is amplified by the power amplifier 22 and be broadcast by the loudspeaker driver of the solar outdoor speaker 2.

Furthermore, the solar wireless audio system has an advantage of being able to switch between the sleep mode and the active mode, thereby providing automatic wake-up. When the audio detection circuit 24 does not detect any audio signal from the receiving circuit 21 and the audio input port 23, the audio detection circuit 24 will transmit a particular type of detection signal to the power management circuit 25. Then, the power management circuit 25 will shut down the power for the power amplifier 22, and the solar outdoor speaker 2 will be switched into the sleep mode.

When the audio detection circuit 24 does detect at least one audio signal from the receiving circuit 21 and the audio input port 23, the audio detection circuit 24 will transmit another particular type of detection signal to the power management circuit 25. Then, the power management circuit 25 will turn on the electric power for the power amplifier 22, and the solar outdoor speaker 2 will be switched into the active mode, thereby providing automatic wake-up.

While the preferred embodiment of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A solar wireless audio system, comprising:
a transmitting portion, the transmitting portion comprising a transmitting circuit and an audio input device connected with an input of the transmitting circuit; and
a solar outdoor speaker, the solar outdoor speaker comprising a receiving circuit and a power amplifier, the receiving circuit is placed inside the solar outdoor speaker, and the power amplifier is connected with an output of the receiving circuit;
wherein, the audio input device has a connecting interface for an iPod player, an audio detection circuit and a power management circuit are placed inside the solar outdoor speaker, an input of the audio detection circuit is connected with an output of the receiving circuit, an output of the audio detection circuit is connected with the inputs of the power management circuit and the power amplifier, respectively, and an output of the power management circuit is connected with a power control terminal of the power amplifier.

2. The solar wireless audio system of claim 1, wherein the transmitting portion comprises a low power player, and the audio input device is connected with an input of the low power player.

3. The solar wireless audio system of claim 1, wherein the audio input device further comprises an audio input port.

4. The solar wireless audio system of claim 1, wherein the audio input device further comprises an AM/FM receiving circuit for receiving public broadcasts.

5. The solar wireless audio system of claim 1, further comprising an audio source selection remote controller and an audio source selection circuit, wherein the audio source selection circuit, corresponding to the audio source selection remote controller, is connected between the audio input device and an input of the transmitting circuit.

6. The solar wireless audio system of claim 1, wherein the electric power for the transmitting portion is supplied by public electric utility via a power adapter.

7. The solar wireless audio system of claim 1, wherein the electric power for the transmitting portion is supplied by a rechargeable battery.

8. The solar wireless audio system of claim 7, wherein the transmitting portion comprises a solar panel and the rechargeable battery is recharged by the solar panel.

9. The solar wireless audio system of claim 1, wherein an audio input port is disposed on the shell of the solar outdoor speaker, and the audio input port is connected with the input of the audio detection circuit.
